(19) United States
(12) Patent Application Publication
(10) Pub. No.: US 2026/0270967 A1
(43) Pub. Date: Sep. 10, 2026

(54) MULTIPLE MRU TRANSMISSION METHODS FOR NEXT-GENERATION WLAN SYSTEMS

(71) Applicant: MEDIATEK INC., Hsinchu City (TW)

(72) Inventors: Shengquan HU, San Jose, CA (US); Jianhan LIU, San Jose, CA (US); Thomas Edward PARE, JR., San Jose, CA (US)

(21) Appl. No.: 19/166,223

(22) PCT Filed: Jun. 7, 2024
(86) PCT No.: PCT/CN2024/098235

§ 371 Date: Sep. 17, 2025

Related U.S. Application Data
(60) Provisional application No. 63/507,127, filed on Jun. 9, 2023.

(51) Int. Cl. H04W 72/0453; H04L 1/00; H04W 84/12

(52) U.S. Cl. CPC H04W 72/0453; H04L 1/0003; H04W 84/12

(57) ABSTRACT

Techniques pertaining to multiple multi-resource unit (MRU) transmission methods for next-generation wireless local area network (WLAN) systems in wireless communications are described. An apparatus (e.g., a station (STA)) generates a multiple multi-resource unit (MMRU). The apparatus communicates with the MMRU in a wireless communication. The MMRU includes a combination of more than one multi-resource units (MRUs), a combination of more than one resource units (RUs), or a combination of more than one RUs and more than one MRUs.

### CROSS REFERENCE TO RELATED PATENT APPLICATION

The present disclosure is part of a non-provisional patent application claiming the priority benefit of U.S. Provisional Patent Application No. 63/507,127, filed 9 Jun. 2023, the content of which herein being incorporated by reference in its entirety.

### TECHNICAL FIELD

The present disclosure is generally related to wireless communications and, more particularly, to multiple multi-resource unit (MRU) transmission methods for next-generation wireless local area network (WLAN) systems in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) and WLANs in accordance with the Institute of Electrical and Electronics Engineers (IEEE) 802.11 standards, resource units (RUs) are introduced under IEEE 802.11ax (High-Efficiency (HE) communications) to enable orthogonal frequency-divisional multiple-access (OFDMA) scheduling and transmissions, and IEEE 802.11be (Extremely High-Throughput (EHT) communications) defines MRUs to utilize the spectrum more efficiently and flexibly. For next-generation Wi-Fi, such as IEEE 802.11bn (Ultra-High Reliability (UHR) communications), there still remain certain issues that need to be addressed. For example, system throughput at different signal-to-interference-and-noise ratio (SINR) levels needs to be improved. Additionally, latency needs to be reduced. Moreover, spectral efficiency also needs to be improved. Therefore, there is a need for a solution of multiple MRU transmission methods for next-generation WLAN systems in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to multiple MRU transmission methods for next-generation WLAN systems in wireless communications. It is believed that implementations of various schemes proposed herein may improve system throughput at different SINR levels, reduce latency, and improve spectral efficiency for next-generation WLAN systems (e.g., IEEE 802.11bn and UHR communications). Under the various proposed schemes, wider bandwidths may be utilized, unequal modulation (UEQM) transmissions may be performed, and multi-layer coding (MLC)/transmissions may be performed. Moreover, multiple MRU (MMRU) may be formed by combining existing MRUs (and/or RUs) on any frequency subblocks of 80 MHz, 160 MHz and/or 320 MHz. The MMRUs may be applied for wider bandwidths such as, for example, 480 MHz and 640 MHz, with UEQM and/or MLC in frequency-domain transmissions.

In one aspect, a method may involve generating a multiple multi-resource unit (MMRU). The method may also involve communicating with the MMRU in a wireless communication. The MMRU may include a combination of more than one multi-resource units (MRUs), a combination of more than one resource units (RUs), or a combination of more than one RUs and more than one MRUs.

In another aspect, an apparatus may include a transceiver configured to communicate wirelessly and a processor coupled to the transceiver. The processor may generate an MMRU. The method may also involve communicating with the MMRU in a wireless communication. The MMRU may include a combination of more than one MRUs, a combination of more than one RUs, or a combination of more than one RUs and more than one MRUs.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example scenario under a proposed scheme in accordance with the present disclosure.

FIG. 9 is a diagram of an example scenario under a proposed scheme in accordance with the present disclosure.

FIG. 10 is a block diagram of an example communication system in accordance with an implementation of the present disclosure.

FIG. 11 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to multiple MRU transmission methods for next-generation WLAN systems in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (RRU) refers to a RU with tones that are continuous (e.g., adjacent to one another) and not interleaved, interlaced or otherwise distributed. Moreover, a 26-tone regular RU may be interchangeably denoted as RU26 (or RRU26), a 52-tone regular RU may be interchangeably denoted as RU52 (or RRU52), a 106-tone regular RU may be interchangeably denoted as RU106 (or RRU106), a 242-tone regular RU may be interchangeably denoted as RU242 (or RRU242), and so on. Moreover, an aggregate (26+52)-tone regular multi-RU (MRU) may be interchangeably denoted as MRU78 (or rMRU78), an aggregate (26+106)-tone regular MRU may be interchangeably denoted as MRU132 (or rMRU132), and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

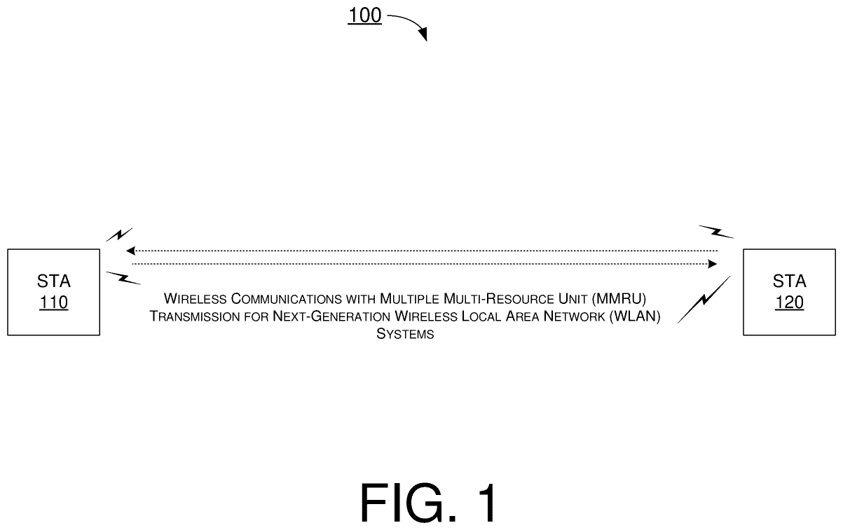

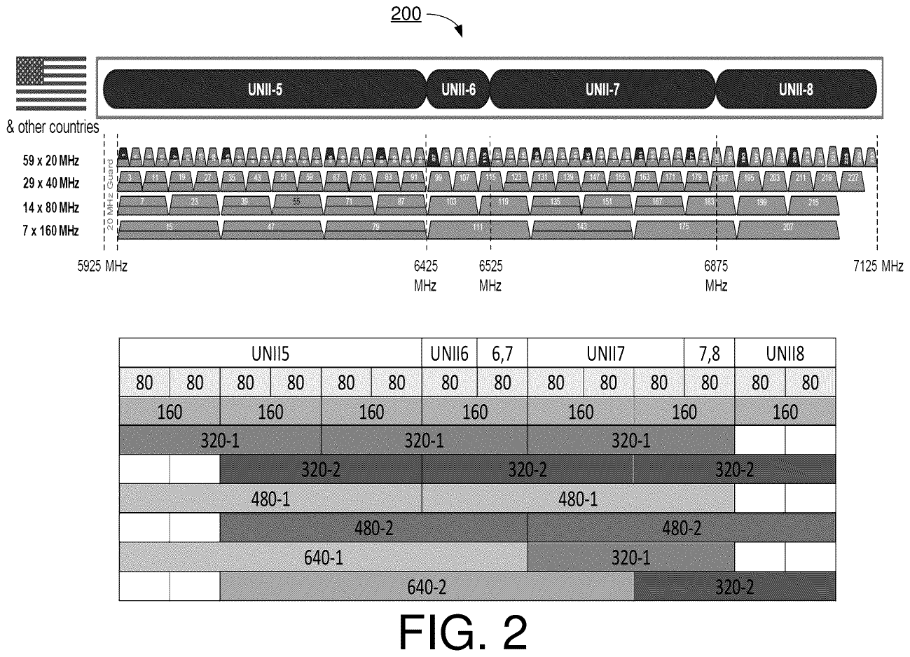

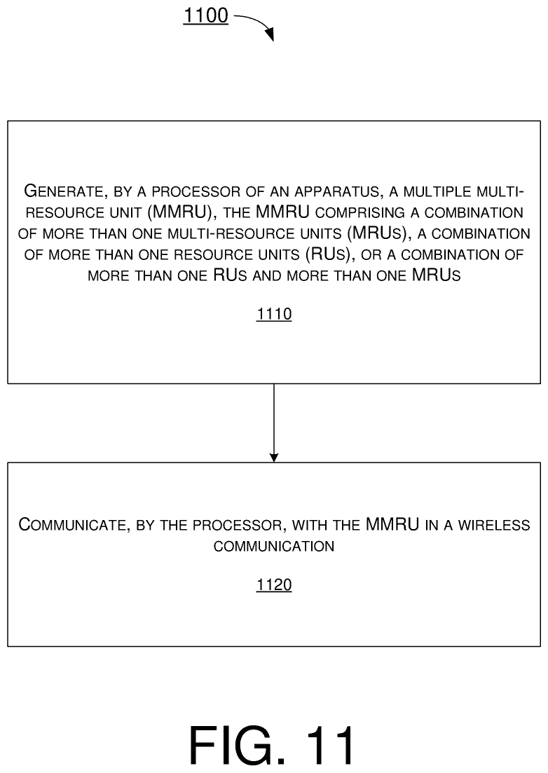

FIG. 1 illustrates an example network environment 100 in which various solutions and schemes in accordance with the present disclosure may be implemented. FIG. 2~FIG. 11 illustrate examples of implementation of various proposed schemes in network environment 100 in accordance with the present disclosure. The following description of various proposed schemes is provided with reference to FIG. 1~FIG. 11.

Referring to FIG. 1, network environment 100 may involve at least a station (STA) 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the multiple MRU transmission methods for next-generation WLAN systems in wireless communications in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In wireless communications in accordance with IEEE 802.11ax and IEEE 802.11be, one user (or STA) may only be assigned with either one RU or one predefined MRU. Under various proposed schemes in accordance with the present disclosure, RU and MRU scheduling may be extended to multiple MRU (MMRU) or extended (or enhanced) MRU (EMRU). For instance, an MMRU (or EMRU) may allow one STA (e.g., STA 110 or STA 120) to be assigned with multiple predefined MRUs (or new, yet-to-be defined MRUs in IEEE 802.11bn) such as MRU (484+242)+MRU (3×996), for example. Additionally, an MMRU (or EMRU) may allow one STA (e.g., STA 110 or STA 120) to be assigned with multiple RUs not defined as MRU in IEEE 802.11be such as RU484+RU484 or RU242+RU242 or RU52+RU242, for example. Moreover, an MMRU (or EMRU) may allow one STA (e.g., STA 110 or STA 120) to be assigned with multiple RUs and multiple MRUs such as RU2×996+MRU (3×996+484) or RU242+MRU (484+242), for example. Furthermore, an MMRU (or EMRU) may allow one STA (e.g., STA 110 or STA 120) to be assigned with more than one RU or MRU with different small or large RU/MRU size combinations such as MRU (106+26)+RU996, for example, and this type of MMRU (or EMRU) may be applied for MLC transmission with unequal modulation and coding scheme (MCS).

FIG. 2 illustrates an example scenario 200 under a proposed scheme in accordance with the present disclosure. Scenario 200 may pertain to channelization for wider bandwidths in 6 GHz. Referring to FIG. 2, 80 MHz, 160 MHz and/or 320 MHz channel may be defined in 6 GHz frequency band (e.g., in Wi-Fi 7/IEEE 802.11be). For future next-generation WLANs (e.g., Wi-Fi 8 and Ultra-High Reliabiilty (UHR) systems), wider bandwidths such as 480 MHz and 640 MHz may be utilized, as shown in FIG. 2.

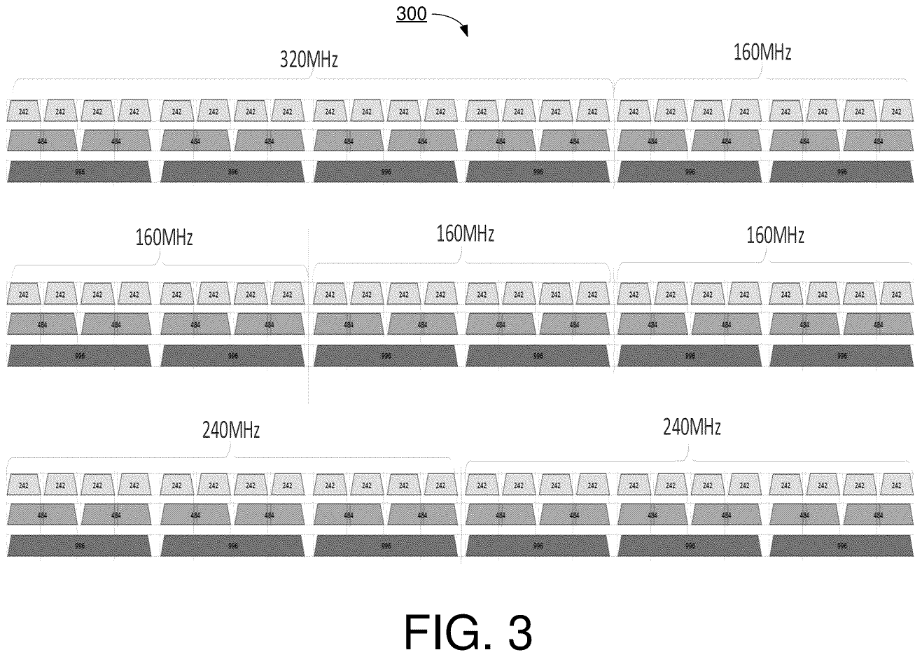

FIG. 3 illustrates an example scenario 300 under a proposed scheme in accordance with the present disclosure. Scenario 300 may pertain to MMRU for wider bandwidth 480 MHz in 6 GHz. Under the proposed scheme, a RU tone plan of the wider bandwidth 480 MHz may be considered as combining the RU tone plans of 320 MHz and 160 MHz or, alternatively, building from six 80 MHz frequency subblocks, three 160 MHz frequency subblocks or two 240 MHz frequency subblocks. Accordingly, the MRU options of 480 MHz may be considered as combining 10 any existing MRU of 320 MHz and existing MRU of 160 MHz or, alternatively, combining any existing MRU from three 160 MHz frequency subblocks. That is, an MMRU may be formed by combining any existing MRUs from multiple frequency subblocks.

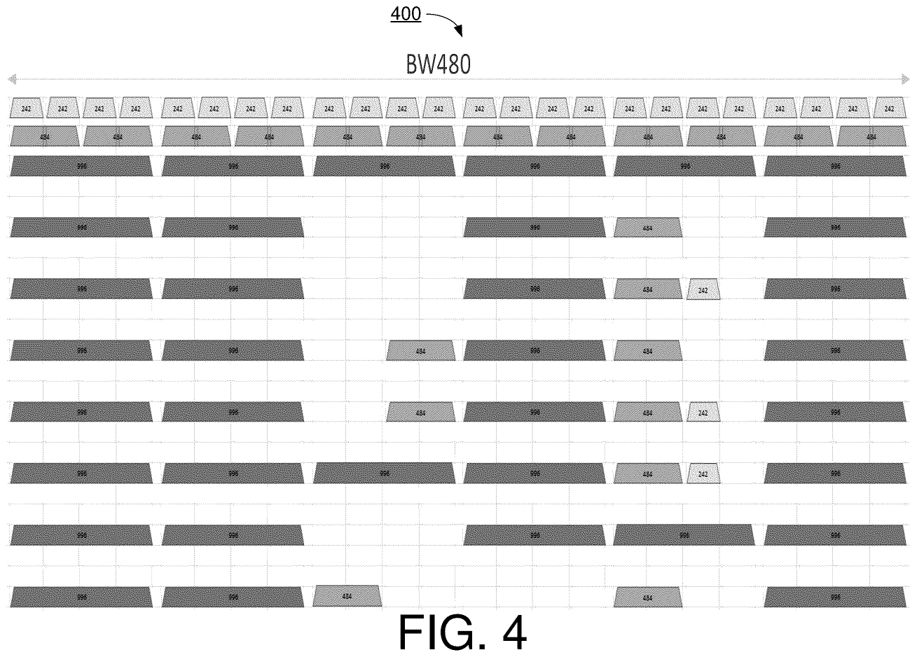

FIG. 4 illustrates an example scenario 400 under a proposed scheme in accordance with the present disclosure. Scenario 400 may pertain to MRU on 480 MHz. Under the proposed scheme, an MMRU may be formed by combining any existing MRU on 320 MHz and any existing MRU on 160 MHz. For instance, there may be three options on 320 MHz, namely: MRU (2×996+484), MRU (3×996), and MRU (3×996+484). There may be two options on 160 MHz, namely: MRU (996+484) and MRU (996+484+242). The MMRU may also allow the combination of MRU with large RUs such as RU996 or RU2×996 or RU4×996, and the like. The MMRU may be transmitted with UEQM and/or MLC applied.

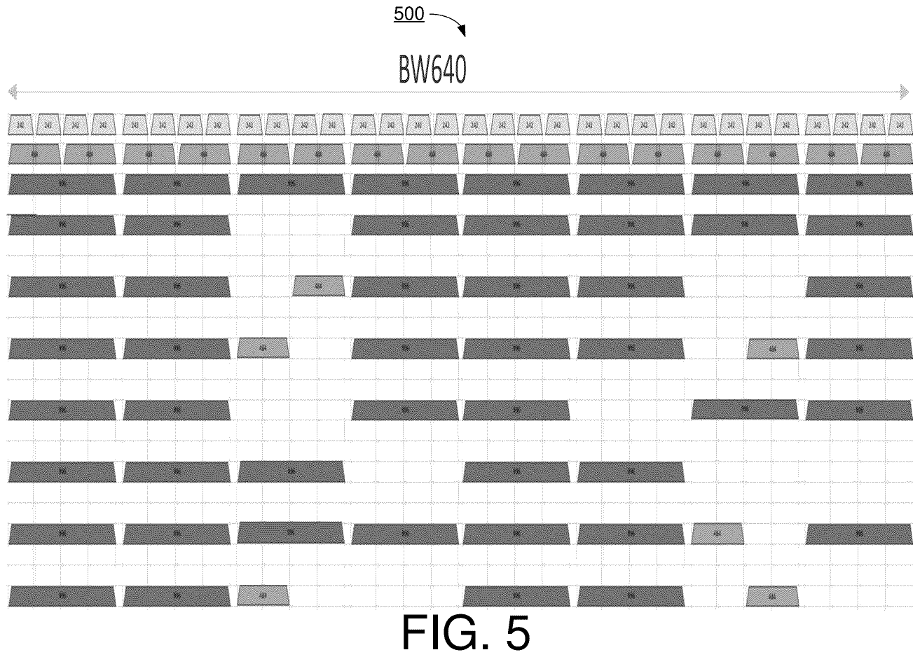

FIG. 5 illustrates an example scenario 500 under a proposed scheme in accordance with the present disclosure. Scenario 500 may pertain to MMRU for wider bandwidth 640 MHz in 6 GHz. Under the proposed scheme, a RU tone plan of the wider bandwidth 640 MHz may be considered as combining the RU tone plans of 320 MHz and 160 MHz or, alternatively, building from eight 80 MHz frequency subblocks, four 160 MHz frequency subblocks or two 320 MHz frequency subblocks. Accordingly, the MRU options of 640 MHz may be considered as combining any existing MRU from two 320 MHz frequency subblocks or, alternatively, combining any existing MRU from four 160 MHz frequency subblocks or, alternatively, combining any existing MRU from 320 MHz and 160 MHz or 80 MHz frequency subblocks. That is, an MMRU may be formed by combining any existing MRUs from multiple frequency subblocks. Under the proposed scheme, a STA (e.g., STA 110 or STA 120) may be assigned with multiple MRUs (MMRU). The MMRU may be transmitted with UEQM and/or MLC applied.

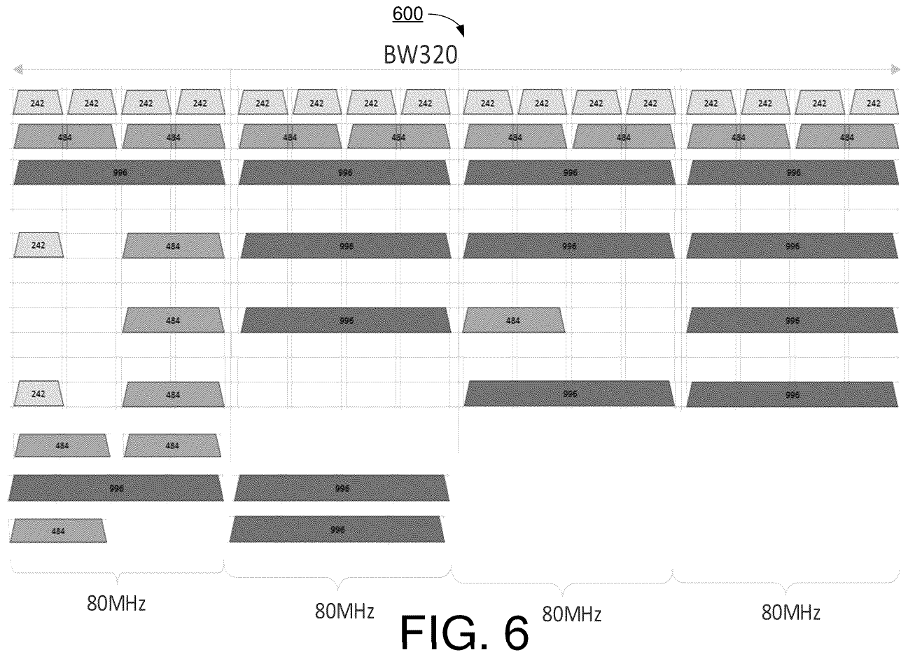

FIG. 6 illustrates an example scenario 600 under a proposed scheme in accordance with the present disclosure. Scenario 600 may pertain to MMRU for UEQM transmission. Under the proposed scheme, MMRU may be used with UEQM transmission. A user (e.g., STA 110 or STA 120) may be assigned with multiple RUs or MRUs, with each RU or MRU scheduled with a different quadrature amplitude modulation (QAM) level. The MMRU may be applied on 80 MHz, 160 MHz, 320 MHz or 480 MHz, for example. Referring to FIG. 6, in one example, a first QAM (QAM1) may be applied on MRU (484+242) while a second QAM (QAM2) may be applied on MRU (3×996). In another example, QAM1 may be applied on one MRU (996+484) and QAM2 may be applied on another MRU (996+484). In another example, QAM1 may be applied on MRU (484+242) and QAM2 may be applied on RU (2×996). In another example, QAM1 may be applied on one RU (484) and QAM2 may be applied on another RU (484). In another example, QAM1 may be applied on one RU (996) and QAM2 may be applied on another RU (996). In yet another example, QAM1 may be applied on RU (484) and QAM2 may be applied on RU (996).

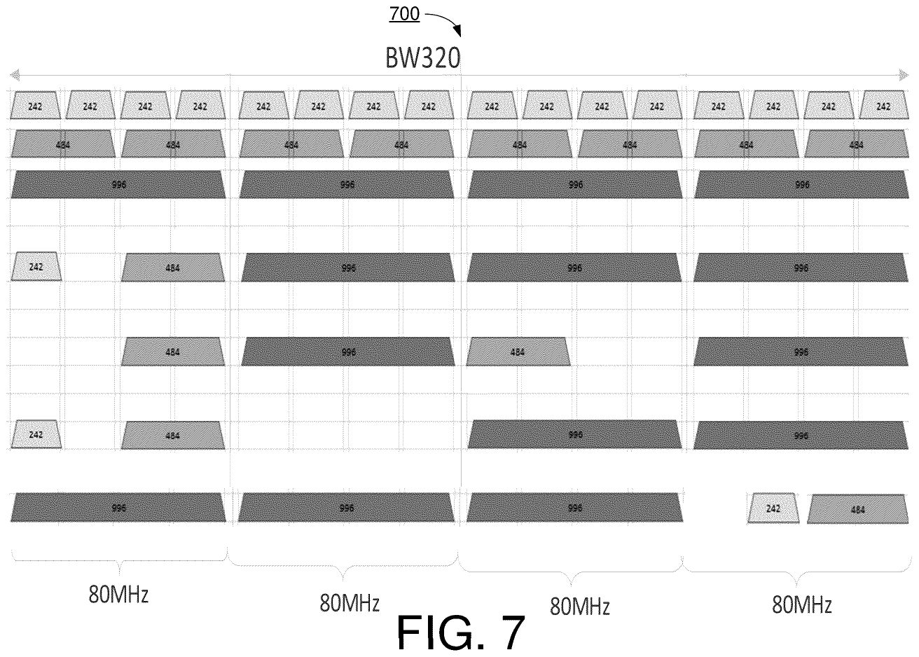

FIG. 7 illustrates an example scenario 700 under a proposed scheme in accordance with the present disclosure. Scenario 700 may pertain to MMRU for MLC transmission. Under the proposed scheme, MMRU may be used with MLC transmission. A user (e.g., STA 110 or STA 120) may be assigned with multiple physical-layer service data units (PSDUs) on multiple RUs or MRUs, with each PSDU on each RU or MRU scheduled with a different MCS level. The MMRU may be applied on 80 MHz, 160 MHz, 320 MHz or 480 MHz, for example. Referring to FIG. 7, in one example, a first PSDU (PSDU1) may be applied with a first MCS (MCS-x) on MRU (484+242) and a second PSDU (PSDU2) may be applied with a second MCS (MCS-y) on MRU (3×996). In another example, PSDU1 may be applied with MCS-x on one MRU (996+484) and PSCU2 may be applied with MCS-y on another MRU (996+484). In another example, PSDU1 may be applied with MCS-x on MRU (484+242) and PSCU2 may be applied with MCS-y on MRU (2×996). In yet another example, PSDU1 may be applied with MCS-x on MRU (484+242) and PSCU2 may be applied with MCS-y on MRU (3×996).

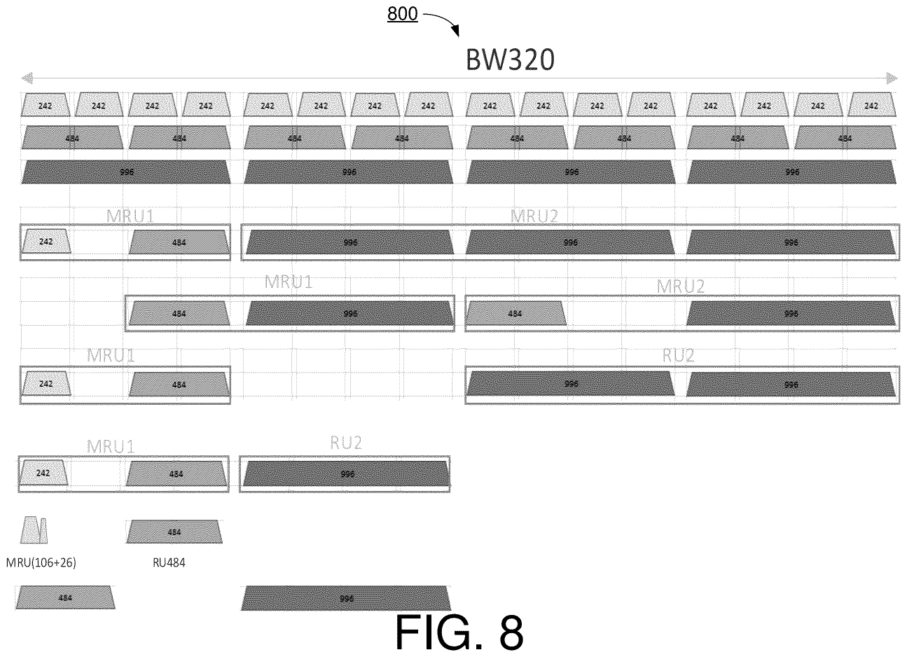

FIG. 8 illustrates an example scenario 800 under a proposed scheme in accordance with the present disclosure. Scenario 800 may pertain to MMRU for 80 MHz, 160 MHz and 320 MHz. In Wi-Fi 7/IEEE 802.11be, only one MRU may be assigned to a user (or one STA). Under the proposed scheme, more than one MRU (or MRU+RU) may be extended to a user (or STA) for future WLAN systems (e.g., Wi-Fi 8) for UEQM or MLC transmission. The MMRU may be based on existing MRU combination defined in IEEE 802.11be/Extremely High-Efficiency (EHT) systems. For UEQM transmission, it may be assumed that an MMRU includes only large MRUs or large RUs. For MLC transmission in the frequency domain, one user (or STA) may be assigned with MRUs/RUs of different sizes for each PSDU. Referring to FIG. 8, in one example, QAM1 or PSDU1 (MCS-x) may be applied on a first MRU (MRU1) and QAM2 or PSDU2 (MCS-y) may be applied on a second MRU (MRU2). In another example, QAM1 or PSDU1 (MCS-x) may be applied on MRU1 and QAM2 or PSDU2 (MCS-y) may be applied on a second RU (RU2). In another example, PSDU1 (MCS-x) may be applied on MRU (106+26) and PSDU2 (MCS-y) may be applied on RU484. In yet another example, PSDU1 (MCS-x) may be applied on RU996 and PSDU2 (MCS-y) may be applied on RU484.

Under a proposed scheme in accordance with the present disclosure, a proportional round robin segment parser may be utilized for MMRU. The segment parser may be performed or utilized per 80 MHz frequency segment. There may be four large RU/MRU sizes in each 80 MHz frequency segment, namely: RU242, RU484, MRU (484+242), and RU996. The proportional round robin (PRR) segment parser may be performed or utilized based on the RU/MRU size ratio inside each MMRU. For instance, in case that the minimum size of RU/MRU in an MMRU is 242 tones, then the ratio for each RU/MRU in each 80 MHz may be given by: RU242: 1s (or 1sⱼ for UEQM), RU484: 2s (or 2sⱼ for UEQM), MRU (484+242): 3s (or 3sⱼ for UEQM), RU996: 4s (or 4sⱼ for UEQM), and leftover bits on RU996: 44*Nbpscs (or 44*Nbpscs,ᵢ). Here, Nbpscs denotes a number of coded bits per subscriber per stream, and Nbpscs,ᵢ denotes a number of coded bits per subscriber per stream for user i. Else, in case that the minimum size of RU/MRU in the MMRU is 484 tones and without MRU (484+242), then the ratio for each RU/MRU in each 80 MHz may be given by: RU484: 1s (or 1sⱼ for UEQM), RU996: 2s (or 2sⱼ for UEQM), and leftover bits on RU996: 44 Nbpscs (or 44*Nbpscs,ᵢ). Else, in case that there is one MRU (484+242) inside the MMRU, then the ratio for each RU/MRU in each 80 MHz may be given by: RU484: 2s (or 2sⱼ for UEQM), MRU (484+242): 3s (or 3sⱼ for UEQM), RU996: 4s (or 4sⱼ for UEQM), and leftover bits on RU996: 44*Nbpscs (or 44*Nbpscs,ᵢ). Else, in case that the minimum size of RU/MRU in the MMRU is 996 tones, then the ratio for each RU/MRU in each 80 MHz may be given by: RU996: 1s (or 1sⱼ for UEQM), and leftover bits on RRU996: 0.

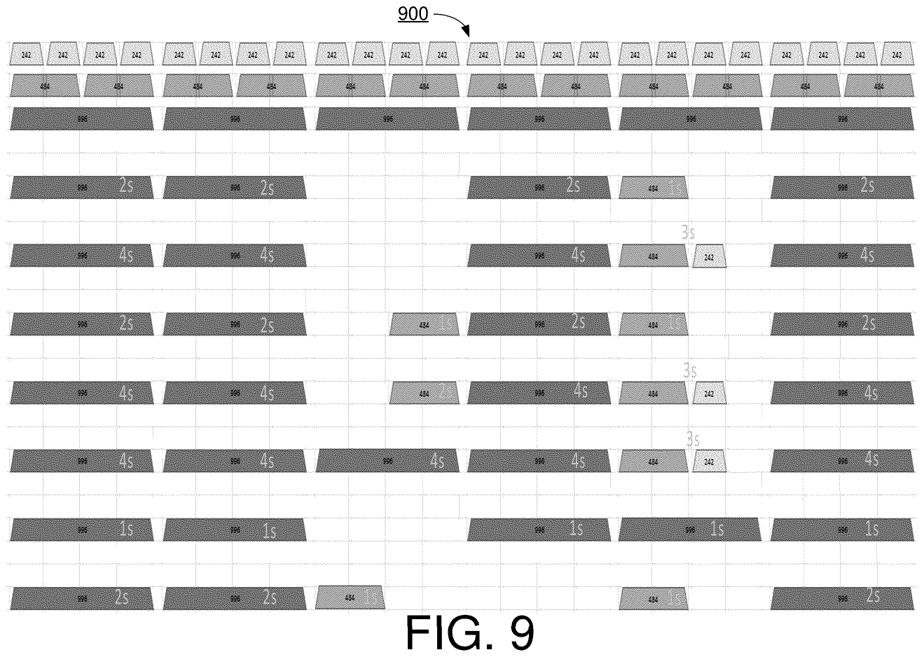

FIG. 9 illustrates an example scenario 900 under a proposed scheme in accordance with the present disclosure. Scenario 900 may pertain to PRR segment parser for MMRU. The example shown in FIG. 9 is for equal QAM. For UEQM, “s” in FIG. 9 may be replaced by “sⱼ”. As for the formula for PPR segment parser processing, the bits in each block of N_{CBPSS} (number of coded bits per orthogonal frequency-division multiplexing (OFDM) symbol per spatial stream) bits may be determined by the segment parser as follows:

$$\begin{matrix}{y}_{k , l , u} = {x}_{m , u} \\ m = ( {{\sum }^{L - 1}}_{i = 0} {m}_{i} ) \cdot ⌊ \frac{k}{{m}_{l}} ⌋ + {{\sum }^{l - 1}}_{i = 0} {m}_{i} + ( k mod {m}_{l} )\end{matrix}$$

The formula for PRR leftover bits processing may be as follows:

$$m = ( {{\sum }^{L - 1}}_{i = 0} {m}_{i} ) \cdot ⌊ \frac{{N}_{CBPSS , {l}_{0} , u}}{{m}_{{l}_{0}}} ⌋ + ( {{\sum }^{L - 1}}_{i = 0 , i \neq {l}_{0}} {m}_{i} ) \cdot ⌊ \frac{{k}^{′}}{{m}_{l}} ⌋ + {{\sum }^{l - 1}}_{i = 0 , i \neq {l}_{0}} {m}_{i} + ( k mod {m}_{l} )$$

### Illustrative Implementations

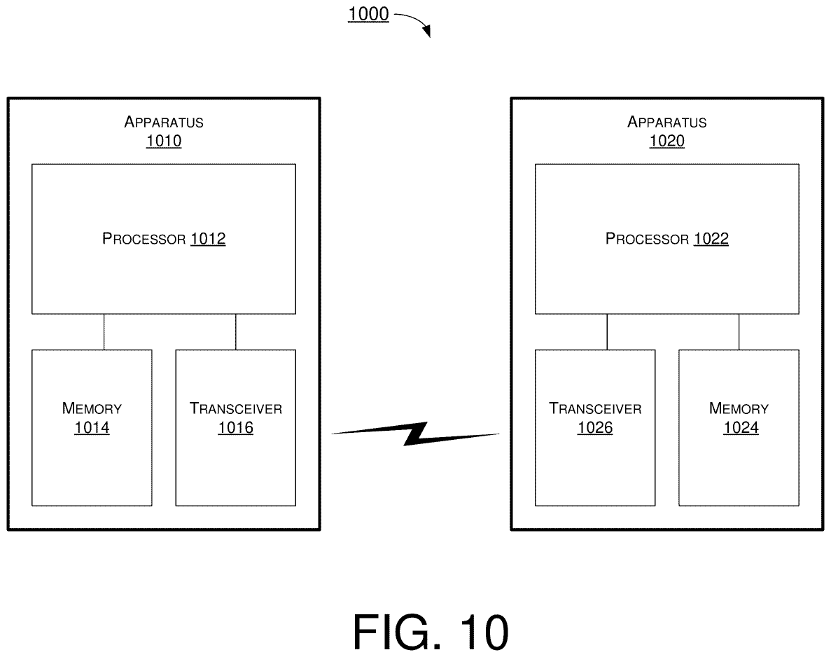

FIG. 10 illustrates an example system 1000 having at least an example apparatus 1010 and an example apparatus 1020 in accordance with an implementation of the present disclosure. Each of apparatus 1010 and apparatus 1020 may perform various functions to implement schemes, techniques, processes and methods described herein pertaining to multiple MRU transmission methods for next-generation WLAN systems in wireless communications including the various schemes described above with respect to various proposed designs, concepts, schemes, systems and methods described above as well as processes described below. For instance, apparatus 1010 may be implemented in STA 110 and apparatus 1020 may be implemented in STA 120, or vice versa.

Each of apparatus 1010 and apparatus 1020 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 1010 and apparatus 1020 may be implemented in a smartphone, a smart watch, a personal digital assistant, a digital camera, or a computing equipment such as a tablet computer, a laptop computer or a notebook computer. Each of apparatus 1010 and apparatus 1020 may also be a part of a machine type apparatus, which may be an IoT apparatus such as an immobile or a stationary apparatus, a home apparatus, a wire communication apparatus or a computing apparatus. For instance, each of apparatus 1010 and apparatus 1020 may be implemented in a smart thermostat, a smart fridge, a smart door lock, a wireless speaker or a home control center. When implemented in or as a network apparatus, apparatus 1010 and/or apparatus 1020 may be implemented in a network node, such as an AP in a WLAN.

In some implementations, each of apparatus 1010 and apparatus 1020 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1010 and apparatus 1020 may be implemented in or as a STA or an AP. Each of apparatus 1010 and apparatus 1020 may include at least some of those components shown in FIG. 10 such as a processor 1012 and a processor 1022, respectively, for example. Each of apparatus 1010 and apparatus 1020 may further include one or more other components not pertinent to the proposed scheme of the present disclosure (e.g., internal power supply, display device and/or user interface device), and, thus, such component(s) of apparatus 1010 and apparatus 1020 are neither shown in FIG. 10 nor described below in the interest of simplicity and brevity.

In one aspect, each of processor 1012 and processor 1022 may be implemented in the form of one or more single-core processors, one or more multi-core processors, one or more RISC processors or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks including those pertaining to multiple MRU transmission methods for next-generation WLAN systems in wireless communications in accordance with various implementations of the present disclosure.

In some implementations, apparatus 1010 may also include a transceiver 1016 coupled to processor 1012. Transceiver 1016 may include a transmitter capable of wirelessly transmitting and a receiver capable of wirelessly receiving data. In some implementations, apparatus 1020 may also include a transceiver 1026 coupled to processor 1022. Transceiver 1026 may include a transmitter capable of wirelessly transmitting and a receiver capable of wirelessly receiving data. It is noteworthy that, although transceiver 1016 and transceiver 1026 are illustrated as being external to and separate from processor 1012 and processor 1022, respectively, in some implementations, transceiver 1016 may be an integral part of processor 1012 as a system on chip (SoC), and transceiver 1026 may be an integral part of processor 1022 as a SoC.

In some implementations, apparatus 1010 may further include a memory 1014 coupled to processor 1012 and capable of being accessed by processor 1012 and storing data therein. In some implementations, apparatus 1020 may further include a memory 1024 coupled to processor 1022 and capable of being accessed by processor 1022 and storing data therein. Each of memory 1014 and memory 1024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1014 and memory 1024 may include a type of read-only memory (ROM) such as mask ROM, programmable ROM (PROM), erasable programmable ROM (EPROM) and/or electrically erasable programmable ROM (EEPROM). Alternatively, or additionally, each of memory 1014 and memory 1024 may include a type of non-volatile random-access memory (NVRAM) such as flash memory, solid-state memory, ferroelectric RAM (FeRAM), magnetoresistive RAM (MRAM) and/or phase-change memory.

Each of apparatus 1010 and apparatus 1020 may be a communication entity capable of communicating with each other using various proposed schemes in accordance with the present disclosure. For illustrative purposes and without limitation, a description of capabilities of apparatus 1010, as STA 110, and apparatus 1020, as STA 120, is provided below in the context of example process 1100. It is noteworthy that, although a detailed description of capabilities, functionalities and/or technical features of apparatus 1020 is provided below, the same may be applied to apparatus 1010 although a detailed description thereof is not provided solely in the interest of brevity. It is also noteworthy that, although the example implementations described below are provided in the context of WLAN, the same may be implemented in other types of networks.

### Illustrative Processes

FIG. 11 illustrates an example process 1100 in accordance with an implementation of the present disclosure. Process 1100 may represent an aspect of implementing various proposed designs, concepts, schemes, systems and methods described above. More specifically, process 1100 may represent an aspect of the proposed concepts and schemes pertaining to multiple MRU transmission methods for next-generation WLAN systems in wireless communications in accordance with the present disclosure. Process 1100 may include one or more operations, actions, or functions as illustrated by one or more of blocks 1110 and 1120. Although illustrated as discrete blocks, various blocks of process 1100 may be divided into additional blocks, combined into fewer blocks, or eliminated, depending on the desired implementation. Moreover, the blocks/sub-blocks of process 1100 may be executed in the order shown in FIG. 11 or, alternatively, in a different order. Furthermore, one or more of the blocks/sub-blocks of process 1100 may be executed repeatedly or iteratively. Process 1100 may be implemented by or in apparatus 1010 and apparatus 1020 as well as any variations thereof. Solely for illustrative purposes and without limiting the scope, process 1100 is described below in the context of apparatus 1010 implemented in or as STA 110 functioning as a non-AP STA or an AP STA and apparatus 1020 implemented in or as STA 120 functioning as an AP STA or a non-AP STA of a wireless network such as a WLAN in network environment 100 in accordance with one or more of IEEE 802.11 standards. Process 1100 may begin at block 1110.

At 1110, process 1100 may involve processor 1012 of apparatus 1010 generating an MMRU. Process 1100 may proceed from 1110 to 1120.

At 1120, process 1100 may involve processor 1012 communicating, via transceiver 1016, with the MMRU in a wireless communication. The MMRU may include a combination of more than one MRUs, a combination of more than one RUs, or a combination of more than one RUs and more than one MRUs.

In some implementations, the MMRU may include MRU (484+242)+MRU (3×996).

In some implementations, the MMRU may include RU484+RU484, RU242+RU242, or RU52+RU242.

In some implementations, the MMRU may include RU2×996+MRU (3×996+484) or RU242+MRU (484+242).

In some implementations, the MMRU may include MRU (106+26)+RU996.

In some implementations, in communicating with the MMRU, process 1100 may involve processor 1012 communicating with the MMRU on a 480 MHz bandwidth. Moreover, a tone plan of the MMRU may include a combination of a RU tone plan of 320 MHz and a RU tone plan of 160 MHz. Alternatively, or additionally, the MMRU may be built from six 80 MHz frequency subblocks. Alternatively, or additionally, the MMRU may be built from three 160 MHz frequency subblocks. Alternatively, or additionally, the MMRU may be built from two 240 MHz frequency subblocks.

In some implementations, in communicating with the MMRU, process 1100 may involve processor 1012 communicating with the MMRU on a 640 MHz bandwidth. Furthermore, a tone plan of the MMRU may include a combination of a RU tone plan of 320 MHz and a RU tone plan of 160 MHz. Alternatively, or additionally, the MMRU may be built from eight 80 MHz frequency subblocks. Alternatively, or additionally, the MMRU may be built from four 160 MHz frequency subblocks. Alternatively, or additionally, the MMRU may be built from two 320 MHz frequency subblocks.

In some implementations, in communicating with the MMRU, process 1100 may involve processor 1012 communicating with the MMRU using an UEQM transmission. In some implementations, a first RU or first MRU of the MMRU may be transmitted with a first QAM and a second RU or second MRU of the MMRU may be transmitted with a second QAM different from the first QAM.

In some implementations, in communicating with the MMRU, process 1100 may involve processor 1012 communicating with the MMRU using an MLC transmission. In some implementations, a first RU or first MRU of the MMRU may be transmitted with a first MCS and a second RU or second MRU of the MMRU may be transmitted with a second MCS different from the first MCS.

In some implementations, in generating the MMRU, process 1100 may involve processor 1012 generating the MMRU by performing proportional round robin segment parsing per 80 MHz frequency segment of the MMRU.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a multiple multi-resource unit (MMRU); and
communicating, by the processor, with the MMRU in a wireless communication,
wherein the MMRU comprises a combination of more than one multi-resource units (MRUs), a combination of more than one resource units (RUs), or a combination of more than one RUs and more than one MRUs.

2. The method of claim 1, wherein the MMRU comprises MRU (484+242)+MRU (3×996).

3. The method of claim 1, wherein the MMRU comprises RU484+RU484, RU242+RU242, or RU52+RU242.

4. The method of claim 1, wherein the MMRU comprises RU2×996+MRU (3×996+484) or RU242+MRU (484+242).

5. The method of claim 1, wherein the MMRU comprises MRU (106+26)+RU996.

6. The method of claim 1, wherein the communicating with the MMRU comprises communicating with the MMRU on a 480 MHz bandwidth, and wherein:
a tone plan of the MMRU comprises a combination of a RU tone plan of 320 MHz and a RU tone plan of 160 MHz; or
the MMRU is built from six 80 MHz frequency subblocks; or
the MMRU is built from three 160 MHz frequency subblocks; or
the MMRU is built from two 240 MHz frequency subblocks.

7. The method of claim 1, wherein the communicating with the MMRU comprises communicating with the MMRU on a 640 MHz bandwidth, and wherein:
a tone plan of the MMRU comprises a combination of a RU tone plan of 320 MHz and a RU tone plan of 160 MHz; or
the MMRU is built from eight 80 MHz frequency subblocks; or
the MMRU is built from four 160 MHz frequency subblocks; or
the MMRU is built from two 320 MHz frequency subblocks.

8. The method of claim 1, wherein the communicating with the MMRU comprises communicating with the MMRU using an unequal modulation (UEQM) transmission.

9. The method of claim 8, wherein a first RU or first MRU of the MMRU is transmitted with a first quadrature amplitude modulation (QAM) and a second RU or second MRU of the MMRU is transmitted with a second QAM different from the first QAM.

10. The method of claim 1, wherein the communicating with the MMRU comprises communicating with the MMRU using a multi-layer coding (MLC) transmission.

11. The method of claim 10, wherein a first RU or first MRU of the MMRU is transmitted with a first modulation and coding scheme (MCS) and a second RU or second MRU of the MMRU is transmitted with a second MCS different from the first MCS.

12. The method of claim 1, wherein the generating of the MMRU comprises generating the MMRU by performing proportional round robin (PRR) segment parsing per 80 MHz frequency segment of the MMRU.

13. An apparatus, comprising:
a transceiver configured to communicate wirelessly; and
a processor coupled to the transceiver and configured to perform operations comprising:
generating a multiple multi-resource unit (MMRU); and
communicating, via the transceiver, with the MMRU in a wireless communication,
wherein the MMRU comprises a combination of more than one multi-resource units (MRUs), a combination of more than one resource units (RUs), or a combination of more than one RUs and more than one MRUs.

14. The apparatus of claim 13, wherein the communicating with the MMRU comprises communicating with the MMRU on a 480 MHz bandwidth, and wherein:
a tone plan of the MMRU comprises a combination of a RU tone plan of 320 MHz and a RU tone plan of 160 MHz; or
the MMRU is built from six 80 MHz frequency subblocks; or
the MMRU is built from three 160 MHz frequency subblocks; or
the MMRU is built from two 240 MHz frequency subblocks.

15. The apparatus of claim 13, wherein the communicating with the MMRU comprises communicating with the MMRU on a 640 MHz bandwidth, and wherein:
a tone plan of the MMRU comprises a combination of a RU tone plan of 320 MHz and a RU tone plan of 160 MHz; or
the MMRU is built from eight 80 MHz frequency subblocks; or
the MMRU is built from four 160 MHz frequency subblocks; or
the MMRU is built from two 320 MHz frequency subblocks.

16. The apparatus of claim 13, wherein the communicating with the MMRU comprises communicating with the MMRU using an unequal modulation (UEQM) transmission.

17. The apparatus of claim 16, wherein a first RU or first MRU of the MMRU is transmitted with a first quadrature amplitude modulation (QAM) and a second RU or second MRU of the MMRU is transmitted with a second QAM different from the first QAM.

18. The apparatus of claim 13, wherein the communicating with the MMRU comprises communicating with the MMRU using a multi-layer coding (MLC) transmission.

19. The apparatus of claim 18, wherein a first RU or first MRU of the MMRU is transmitted with a first modulation and coding scheme (MCS) and a second RU or second MRU of the MMRU is transmitted with a second MCS different from the first MCS.

20. The apparatus of claim 13, wherein the generating of the MMRU comprises generating the MMRU by performing proportional round robin (PRR) segment parsing per 80 MHz frequency segment of the MMRU.
